(19) United States
(12) Patent Application Publication
(10) Pub. No.: US 2021/0174367 A1
(43) Pub. Date: Jun. 10, 2021

(54) SYSTEM AND METHOD INCLUDING ACCURATE SCORING AND RESPONSE

(71) Applicant: Visa International Service Association, San Francisco, CA (US)

(72) Inventors: Theodore D. Harris, San Francisco, CA (US); Craig O'Connell, San Mateo, CA (US); Yue Li, San Mateo, CA (US); Tatiana Korolevskaya, Mountain View, CA (US); Nancy Switzer, Pacifica, CA (US)

(21) Appl. No.: 17/052,432

(22) PCT Filed: May 2, 2019
(86) PCT No.: PCT/US2019/030443

§ 371 Date: Nov. 2, 2020

Related U.S. Application Data
(60) Provisional application No. 62/665,901, filed on May 2, 2018.

(51) Int. Cl. G06Q 20/40; G06F 17/16; G06N 7/00; H04L 12/24

(52) U.S. Cl. CPC G06Q 20/4016; G06F 17/16; H04L 41/142; H04L 41/12; H04L 41/16; G06N 7/005

(57) ABSTRACT

A method includes a processing computer receiving a processing request message comprising user data from a remote server computer. The processing computer can then determine latent values associated with the processing request message based on the user data and a multiplex graph. The processing computer can then normalize the latent values based on a community group in the multiplex graph. The community group can include at least a part of the user data. The processing computer can transmit a processing response message comprising at least one normalized latent value to the remote server computer.

### CROSS-REFERENCES TO RELATED APPLICATIONS

The present application is a non-provisional of and claims priority to U.S. Provisional Application 62/665,901, filed on May 2, 2018, which is incorporated herein by reference for all purposes in its entirety.

### BACKGROUND

Large data sets related to entities are often analyzed to make decisions about those entities. Traditional analysis processes may not be sufficient to accurately analyze the data in the large data sets to arrive at optimal decisions. For example, a server computer can analyze a large data set comprising data associated with the plurality of computers in a computer network to determine if one or more of the computers may need replacement. The data can include data transmission rates (e.g., 8 GB/day), data reception rates (e.g., 4 GB/day), ages of computers (e.g., 2 years), transmission or reception failure rates (e.g., 0.001%), and/or the like. The server computer can determine replacement scores (e.g., based on the probability of failure, the probability of compromise, etc.) for the computers in the plurality of computers.

In this example, traditional analysis processes may not be sufficient to accurately score each computer. For example, data from each computer in the plurality of computers may be analyzed for its performance and can be evaluated and scored. However, the resulting scores may not be accurate, since environmental factors may not be taken into account. For example, if a particular computer is located in a sub-network that contains computers that perform poorly (e.g., are infected with malware, are not properly maintained, etc.), then the score associated with that particular computer may not be accurate since its operation may depend upon other computers in its network. If that particular computer is placed in a different network with computers that did not have operational issues that are present in the particular computer's current network, then that particular computer may have a lower replacement score than the score that would normally be assigned to it while it is in the particular computer's current network.

Embodiments of the invention address this problem and other problems individually and collectively.

### SUMMARY

Embodiments of the invention are related to methods and systems for determining latent values and making determinations based upon the latent values.

One embodiment is directed to a method comprising: receiving, by a processing computer, a processing request message comprising user data from a remote server computer; determining, by the processing computer, latent values associated with the processing request message based on the user data and a multiplex graph; normalizing, by the processing computer, the latent values based on a community group in the multiplex graph, wherein the community group includes at least a part of the user data; and transmitting, by the processing computer, a processing response message comprising at least one normalized latent value to the remote server computer.

Another embodiment is directed to a processing computer comprising: a processor; and a computer-readable medium coupled to the processor, the computer-readable medium comprising code executable by the processor for implementing a method comprising: receiving a processing request message comprising user data from a remote server computer; determining latent values associated with the processing request message based on the user data and a multiplex graph; normalizing the latent values based on a community group in the multiplex graph, wherein the community group includes at least a part of the user data; and transmitting a processing response message comprising at least one normalized latent value to the remote server computer.

One embodiment is directed to a method comprising: a method comprising: receiving, by a remote server computer, a user request; compiling, by the remote server computer, user data based on the user request; generating, by the remote server computer, a processing request message comprising the user data; transmitting, by the remote server computer, the processing request message to a processing computer, wherein the processing computer determines latent values associated with the user data and normalizes the latent values based on a community group, wherein the community group includes at least a part of the user data; receiving, by the remote server computer, a processing response message comprising at least one normalized latent value from the processing computer; and performing, by the remote server computer, additional processing based on the at least one normalized latent value.

One embodiment is directed to a remote server computer comprising: a processor; and a computer-readable medium coupled to the processor, the computer-readable medium comprising code executable by the processor for implementing a method comprising: receiving a user request; compiling user data based on the user request; generating a processing request message comprising the user data; transmitting the processing request message to a processing computer, wherein the processing computer determines latent values associated with the user data and normalizes the latent values based on a community group, wherein the community group include at least a part of the user data; receiving a processing response message comprising at least one normalized latent value from the processing computer; and performing additional processing based on the at least one normalized latent value.

Further details regarding embodiments of the invention can be found in the Detailed Description and the Figures.

### BRIEF DESCRIPTION OF THE DRAWINGS

FIG. 1 shows a block diagram of a system according to embodiments.

FIG. 2 shows a block diagram of a processing computer according to embodiments.

FIG. 3 shows a block diagram of a remote server computer according to embodiments.

FIG. 4 shows a multiplex graph according to embodiments.

FIG. 5 shows a method of processing a request according to embodiments.

FIG. 6 shows a method of latent value detection in a dynamic multiplex graphs according to embodiments.

FIG. 7 shows example matrices according to embodiments.

### DETAILED DESCRIPTION

Prior to discussing embodiments of the invention, some terms can be described in further detail.

The term “artificial intelligence model” or “AI model” may include a model that may be used to predict outcomes in order achieve a target goal. The AI model may be developed using a learning algorithm, in which training data is classified based on known or inferred patterns. One type of AI model may be a “machine learning model.”

“Machine learning” may refer to an artificial intelligence process in which software applications may be trained to make accurate predictions through learning. The predictions can be generated by applying input data to a predictive model formed from performing statistical analysis on aggregated data. Machine learning that involves learning patterns from a topological graph can be referred to as “graph learning.”

“Unsupervised learning” may include a type of learning algorithm used to classify information in a dataset by labeling inputs and/or groups of inputs. One method of unsupervised learning can be cluster analysis, which can be used to find hidden patterns or grouping in data. The clusters may be modeled using a measure of similarity, which can defined using one or metrics, such as Euclidean distance.

A “topological graph” may include a representation of a graph in a plane of distinct vertices connected by edges. The distinct vertices in a topological graph may be referred to as “nodes.” Each node may represent specific information for an event or may represent specific information for a profile of an entity or object. The nodes may be related to one another by a set of edges, E. An “edge” may be described as an unordered pair composed of two nodes as a subset of the graph G=(V, E), where is G is a graph comprising a set V of vertices (nodes) connected by a set of edges E. For example, a topological graph may represent a transaction network in which a node representing a transaction may be connected by edges to one or more nodes that are related to the transaction, such as nodes representing information of a device, a user, a transaction type, etc. An edge may be associated with a numerical value, referred to as a “weight”, that may be assigned to the pairwise connection between the two nodes. The edge weight may be identified as a strength of connectivity between two nodes and/or may be related to a cost or distance, as it often represents a quantity that is required to move from one node to the next.

A “subgraph” or “sub-graph” may include a graph formed from a subset of elements of a larger graph. The elements may include vertices and connecting edges, and the subset may be a set of nodes and edges selected amongst the entire set of nodes and edges for the larger graph. For example, a plurality of subgraph can be formed by randomly sampling graph data, wherein each of the random samples can be a subgraph. Each subgraph can overlap another subgraph formed from the same larger graph.

A “community” may include a group/collection of nodes in a graph that are densely connected within the group. A community may be a subgraph or a portion/derivative thereof and a subgraph may or may not be a community and/or comprise one or more communities. A community may be identified from a graph using a graph learning algorithm, such as a graph learning algorithm for mapping protein complexes. Communities identified using historical data can be used to classify new data for making predictions. For example, identifying communities can be used as part of a machine learning process, in which predictions about information elements can be made based on their relation to one another. For example, nodes with similar characteristics (e.g., locations, temperatures, colors, etc.) can be clustered into a community. New nodes may later be compared to the community groups to predict which community the new nodes should be associated with. For further details on community group determination see [Fortunato, Santo. “Community detection in graphs.” Physics reports 486.3-5 (2010): 75-174.] which is incorporated herein for all purposes. Community groups are also described in detail in WO 2018/013566, corresponding to PCT application no. PCT/US2017/041537, filed on Jul. 11, 2017, which is herein incorporated by reference in its entirety.

A “data set” may include a collection of related sets of information composed of separate elements that can be manipulated as a unit by a computer. A data set may comprise known data, which may be seen as past data or “historical data.” Data that is yet to be collected or labeled, may be referred to as future data or “unknown data.” When future data is received at a later point it time and recorded, it can be referred to as “new known data” or “recently known” data, and can be combined with initial known data to form a larger history.

“Network data” can include a network of data. In some embodiments, network data may be in the form of a graph and a plurality of network data can make up a multiplex graph, which may be represented by a higher-order tensor. Network data can include any suitable data (e.g., fraud network data, transaction network data, weather network data, etc.).

A “multiplex graph” may be a graph where edges between nodes can be of different types. A multiplex graph can comprise a plurality of network data. For example, a multiplex graph can include fraud network data, weather network data, purchase network data where the type of edges may differ between each network data in the multiplex graph. For example, the edges between nodes in the fraud network data may connect nodes with similar fraud characteristics, whereas the edges in the weather network may connect weather measurements from various weather stations. Further, nodes in different network data can be connected by edges. For example, a node in the fraud network data may be connected via an edge to a node in the weather network data. These nodes may be connected, for example, if the fraud node indicates a fraudulent transaction that occurred during a particular weather event such as a hurricane. The fraud node may connect to the relevant hurricane node. As another example, the nodes of the purchase network data may connect to the nodes of the fraud network data. A particular node of the purchase network data may indicate that a consumer, John, purchased a lawnmower at a hardware store for $399. This node indicating the purchase of the lawnmower may be related to a fraud node in the fraud network data. For example, John may not have actually purchased the lawnmower, his credit card may have been stolen, and the fraudster may have purchased the lawnmower.

“User data” can include data associated with an individual or user. User data can include any suitable type of user data, for example, phone number(s), name(s), physical address(es), email address(es), account number(s), credit score(s), previous interaction history, and/or other user identifying information.

An “interaction” may be a reciprocal action that involves more than one actor. For example, an interaction between devices can include the exchange of data. As another example, interactions between users and resource providers can be referred to as “transactions.”

A “resource provider” may be an entity that can provide a resource such as goods, services, information, and/or access. Examples of resource providers includes merchants, data providers, transit agencies, governmental entities, venue and dwelling operators, etc.

An “adjacency matrix” can include a matrix used to represent a finite graph. The elements of the matrix can indicate whether pairs of vertices are adjacent or not adjacent in the graph. An adjacency matrix may be a square matrix. For example, for a graph with vertex set V, the adjacency matrix can be a square |V|×|X| matrix A such that its element Aᵢⱼ is one when there is an edge from vertex (i.e., node) i to vertex j, and zero when there is no edge between vertex i and vertex j. The diagonal elements of the matrix may all be equal to zero, if no edges from a vertex to itself (i.e., loops) are included in the graph. The same concept can be extended to multigraphs and graphs with loops by storing the number of edges between each two vertices in the corresponding matrix element, and by allowing nonzero diagonal elements. Loops may be counted either once (as a single edge) or twice (as two vertex-edge incidences), as long as a consistent convention is followed. Undirected graphs often use the latter convention of counting loops twice, whereas directed graphs typically use the former convention.

A “degree matrix” can include a matrix which contains information about a degree of each vertex of a graph. The information about a degree of each vertex can include the number of edges attached to each vertex (i.e., a node in a graph). For example, if a node is connected to three other nodes, via three edges, then the degree of said node can be equal to three. In some embodiments, an adjacency matrix and a degree matrix can be used together to construct a Laplacian matrix of a graph. A degree matrix may be a diagonal matrix. For example, given a graph G=(V, E) where V are the vertices (i.e., nodes) and E are the edges, and where the magnitude of V is equal to the total number of nodes n, the degree matrix D for the graph G can be a n×n diagonal matrix. In some embodiments, if the graph is an undirected graph, each loop (e.g., a node connects to itself via an edge) increases the degree of a node by two. In a directed graph, either an indegree (i.e., the number of incoming edges at each node) or an outdegree (i.e., the number of outgoing edges at each node) may be used to mean the degree of a node.

A “tensor” can be a mathematical object represented by an array of components. A tensor can map, in a multi-linear manner, geometric vectors, scalars, and other tensors to a resulting tensor. A tensor can have a rank. A rank 1 tensor may be a vector. A rank 2 tensor may be a matrix. Tensors of rank 3 or higher may be referred to as higher order tensors.

“Tensor factorization” or “tensor decomposition” can be a process for expressing a tensor as a sequence of elementary operations acting on other, typically simpler, tensors. Tensor factorization may be capable of learning connections among known values in a tensor in order to infer missing or latent values. For example, tensor factorization may decompose a tensor into multiple low-rank latent factor matrices representing each tensor-dimension. In some embodiments, tensor factorization can include Tucker decomposition. For further details on tensor factorization as well as its application to latent variables can be found in, for example, [Kolda, Tamara G., and Brett W. Bader. “Tensor decompositions and applications.” SIAM review 51.3 (2009): 455-500.], and [Rabanser, Stephen, et al. “Introduction to Tensor Decompositions and their Applications in Machine Learning” in ArXiv (2017)], which are herein incorporated by reference in their entirety for all purposes. Further, examples of probabilistic latent tensor factorization for audio modeling can be found in, for example, [Cemgil, Ali Taylan, et al. “Probabilistic latent tensor factorization framework for audio modeling.” 2011 IEEE Workshop on Applications of Signal Processing to Audio and Acoustics (WASPAA). IEEE, 2011.], which is herein incorporated by reference in its entirety for all purposes.

A “latent variable” or “latent attribute” may include data that is not directly observed or measured. A latent variable may be inferred from other variables that are observed or measured. In some cases a latent variable may correspond to an aspect of physical reality, which could in principle be measured or observed, but may not for practical reasons. Examples of latent variables include risk score adjustors, categories (e.g., literature, sports, foods, etc.), data structures, etc. In some embodiments, a processing computer can determine a tensor comprising one or more latent variables. A latent variable can be a numeric value derived from a plurality of network data. Additional examples of latent variables can include, for example, network risk (e.g., fraud origination), situation data (e.g., high foot traffic), environmental factors (e.g., hurricane impact), economic heath (e.g., regional trends), device characteristics (e.g., fraud farm characteristics), user characteristics (e.g., mood, propensity, etc.), etc.

A “latent value” can include a value of a latent variables. For example, a latent variable may be predicted water usage, and the corresponding latent value may be 10 gallons. As another example, a latent variable may be an estimated fraudster, and the corresponding latent value may have multiple data items, for example, a location (e.g., coordinates), a method of fraud (e.g., credit card, check, etc.) which may be represented by integers, a rate of attempted fraud (e.g., 2 times per day), and other suitable values used to estimate a fraudulent party.

A “risk score adjustor” can include a value which can adjust a risk score. A risk score adjustor can be an integer, float, double, etc. (e.g., 1.8, 33, etc.). In some embodiments, a risk score adjustor can be a latent value. A computer can use a risk score adjustor to adjust a risk score in any suitable manner. A computer can multiply, or perform any other mathematical operation with, a risk score adjustor and a risk score. For example, a computer can multiply a risk score adjustor of 1.8 and a risk score of 650 to determine an adjusted risk score of 1170.

“Output data” can include data that is output by a computer or software in response to input data. In some embodiments, output data may be determined and/or output by a machine learning model. The output data can depend on the type of machine learning (ML) model. For example, the output data can be a single value if the ML model is a regression model, n classes and a probability that the input is of a class if the ML model is a classification model, a string including a word, a character, a sentence, etc. if the ML model is a text summarization model, etc.

“Additional processing” can include performing one or more processes. In some embodiments, a processing computer can perform additional processing based on determined output data (e.g., output from a model). In other embodiments, a remote server computer can perform additional processing. Additional processing can include any suitable processing capable of being performed by the processing computer and/or the remote server computer. For example, additional processing can include generating and transmitting an alert based on the output data to a remote computer. As further examples, additional processing can include updating routing tables (based on the removal of a computer from a computer network), performing a fraud analysis, performing further analysis on the latent values and/or output data (e.g., adjusting a risk score with a risk score adjustor), and/or other processing based on the output of the model. In some embodiments, additional processing can include opening and/or closing water system valves and/or generating documents (e.g., legal documents, car related documents, automated reports and/or audits, etc.).

A “processor” may include any suitable data computation device or devices. A processor may comprise one or more microprocessors working together to accomplish a desired function. The processor may include a CPU comprising at least one high-speed data processor adequate to execute program components for executing user and/or system-generated requests. The CPU may be a microprocessor such as AMD's Athlon, Duron and/or Opteron; IBM and/or Motorola's PowerPC; IBM's and Sony's Cell processor; Intel's Celeron, Itanium, Pentium, Xeon, and/or XScale; and/or the like processor(s).

A “memory” may be any suitable device or devices that can store electronic data. A suitable memory may comprise a non-transitory computer readable medium that stores instructions that can be executed by a processor to implement a desired method. Examples of memories may comprise one or more memory chips, disk drives, etc. Such memories may operate using any suitable electrical, optical, and/or magnetic mode of operation.

A “server computer” may include a powerful computer or cluster of computers. For example, the server computer can be a large mainframe, a minicomputer cluster, or a group of servers functioning as a unit. In one example, the server computer may be a database server coupled to a Web server. The server computer may be coupled to a database and may include any hardware, software, other logic, or combination of the preceding for servicing the requests from one or more client computers. The server computer may comprise one or more computational apparatuses and may use any of a variety of computing structures, arrangements, and compilations for servicing the requests from one or more client computers.

As an illustrative example, a processing computer can query a data store for a plurality of network data comprising physical performance network data, application network data, and communication traffic network data. For example, the physical performance network data may include RAM utilization, CPU processing rates, and free memory space. The application network data may include a number of queries/operations processed, a number of parallel instances emulated, and application error rates. The communication traffic network data may include communication durations, communication failure rates, communication channel types, and communication rates of particular machines. The processing computer can receive a processing request message comprising a request to analyze a computer network. In some embodiments, the processing request message may be a result of an event in the computer network, for example, a malicious party compromising a computer. The processing computer can also receive a risk score for a particular computer (e.g., a risk score of 70). The processing computer can then determine latent values associated with a processing request message, as described herein. The processing computer can determine a community group, from the plurality of network data, that includes the computer associated with the event.

The plurality of network data may indicate that a groups of nodes, representing computers, are in a high throughput level community group. The nodes in the high throughput level community group may be included in this community based on high RAM utilization and high CPU processing rates. The nodes may have varying numbers of queries/operations processed and application error rates. Further the nodes may have high communication rates. For example, the latent variable may be a risk score adjustor and the determined latent values for nodes in the multiplex graph (which in this example can be associated with computers) may be 1.8, 1.1, 0.6, 0.9, and 1.3. The processing computer can then normalize the latent values based on the community group in the multiplex graph to determine a normalized risk score adjustor. The normalized risk score adjustor for the computer associated with the event can be used to adjust a risk score, and then give a better representation of the risk of the computer.

The processing computer can determine whether or not a computer in the high throughput level community group is performing higher than average given its circumstances. For example, a computer in a high throughput level community group that is performing below expectations may need to be replaced. However, if this same computer was compared to computers in a low throughput level community group it may be overperfoming, thus the processing computer may not determine that the computer needs to be replaced.

Embodiments allow for a system and method configured to increase inclusion based on latent variables determined from subgroups of a multiplex graph. For example, a user may request a loan from an entity (e.g., a bank). The bank or other third party can determine a risk score for the loan based on all loan holders. However, the user may live in an underprivileged area and be denied the loan simply due to where they live.

The entity can operate a remote server computer which is operable to generate and transmit a processing request message comprising user data (e.g., the user's address, phone number, income, debts, etc.) to a processing computer. The processing computer can determine latent values associated with the user's request for a loan. The latent values can include, for example, risk score adjustors, which can later be used to adjust the risk score. The processing computer can then normalize the latent values based on a community group associated with the user. The community group include, for example, other individuals that live in the same area as the user. In this way, the risk score adjustor can take into account the user's underpriviledged area. If the user is a high performer in their community, for example, they have a lower debt than others in the area while having a similar salary and/or other characteristics. The risk score adjustor, which can be used to adjust the risk score, either by the processing computer or the remote server computer, can increase inclusion by allowing for more personalized decisions on loans.

The processing computer can then transmit a processing response message comprising the normalized risk score adjustor to the remote server computer.

### I. Systems

Embodiments are usable with various data processing systems, e.g., payments systems, weather systems, scientific systems, fraud systems, and the like. Although examples of payment systems are described, embodiments are equally applicable for other data processing systems.

A. Overview

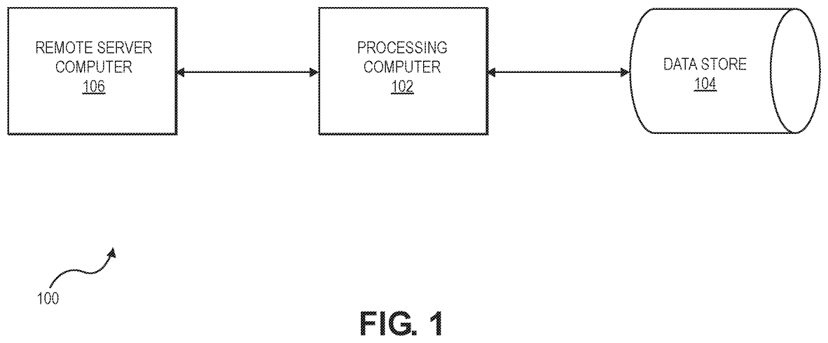

FIG. 1 shows a system 100 comprising a number of components according to embodiments. The system 100 comprises a processing computer 102, a remote server computer 106, and a data store 104. The processing computer 102 may be in operative communication with the remote server computer 106 as well as the data store 104. In some embodiments, the processing computer 102 can be operatively coupled to the data store 104.

The remote server computer 106, the processing computer 102, and the data store 104 may be in operative communication with each other through any suitable communication channel or communications network. Suitable communications networks may be any one and/or the combination of the following: a direct interconnection; the Internet; a Local Area Network (LAN); a Metropolitan Area Network (MAN); an Operating Missions as Nodes on the Internet (OMNI); a secured custom connection; a Wide Area Network (WAN); a wireless network (e.g., employing protocols such as, but not limited to a Wireless Application Protocol (WAP), I-mode, and/or the like); and/or the like. Messages between the computers, networks, and devices may be transmitted using a secure communications protocols such as, but not limited to, File Transfer Protocol (FTP); HyperText Transfer Protocol (HTTP); Secure Hypertext Transfer Protocol (HTTPS), Secure Socket Layer (SSL), ISO (e.g., ISO 8583) and/or the like.

For simplicity of illustration, a certain number of devices are shown in FIG. 1. It is understood, however, that embodiments of the invention may include more than one of each component. For example, in some embodiments, there may be any suitable number of remote server computers 106 (e.g., 2, 5, 7, 10, 20, 50, etc.).

The processing computer 102 can be configured to retrieve data from the data store 104. The processing computer 102 can retrieve data (e.g., a plurality of network data) from the data store 104 in any suitable manner. For example, a query language (e.g., structured query language (SQL)) can be used to prepare data queries, to query data from the data store 104. The data store 104 may store network data (e.g., fraud network data, purchase network data, returns network data, etc.). The data store 104 may be a conventional, fault tolerant, relational, scalable, secure database such as those commercially available from Oracle™ or Sybase™.

The processing computer 102 can be configured to receive a processing request message comprising user data from the remote server computer 106. The processing computer 102 can also be configured to determine latent values associated with the processing request message based on the user data and a multiplex graph comprising a plurality of network data retrieved from the data store 104. The processing computer 102 can be configured to normalize the latent values based on determined community groups. The community groups can include at least a part of the user data. For example, the user data may indicate a zip code of the user. The community group may include data corresponding to users living in the same zip code area. The processing computer can also be configured to transmit a processing response message comprising at least one normalized latent value to the remote server computer 106.

The remote server computer 106 may be a server computer. The remote server computer 106 may be operated by an entity (e.g., a bank). The remote server computer 106 can be configured to receive a user request message and compile user data based on the user request. The remote server computer 106 can also be configured to generate a processing request message comprising the user data and transmit the processing request message requesting normalized latent values to the processing computer 102.

The remote server computer 106 can also be configured to receive a processing response message from the processing computer 102, where the processing response message can be received in response to the processing request message. Based on data received in the processing response message, the remote server computer 106 can be configured to perform additional processing as described in further detail herein.

B. Processing Computer

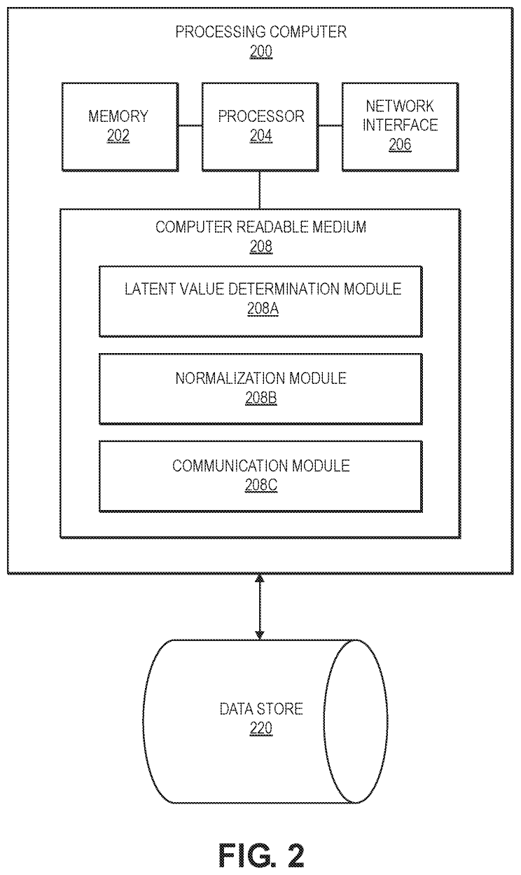

FIG. 2 shows a block diagram of a processing computer 200 according to embodiments. The processing computer 200 may comprise a memory 202, a processor 204, a network interface 206, and a computer readable medium 208 comprising a latent value determination module 208A, a normalization module 208B, and a communication module 208C. The processing computer 200 may be in operative communication with a data store 220.

The memory 202 may store data securely. The memory 202 can store cryptographic keys, network data, user data, routing tables, and/or any other suitable information used in conjunction with the modules.

The network interface 206 may include an interface that can allow the processing computer 200 to communicate with external computers. The network interface 206 may enable the processing computer 200 to communicate data to and from another device (e.g., remote server computer, data store 220, etc.). Some examples of network interface 206 may include a modem, a physical network interface (such as an Ethernet card or other Network Interface Card (NIC)), a virtual network interface, a communications port, a Personal Computer Memory Card International Association (PCMCIA) slot and card, or the like. The wireless protocols enabled by network interface 206 may include Wi-Fi™. Data transferred via network interface 206 may be in the form of signals which may be electrical, electromagnetic, optical, or any other signal capable of being received by the external communications interface (collectively referred to as “electronic signals” or “electronic messages”). These electronic messages that may comprise data or instructions may be provided between network interface 206 and other devices via a communications path or channel. As noted above, any suitable communication path or channel may be used such as, for instance, a wire or cable, fiber optics, a telephone line, a cellular link, a radio frequency (RF) link, a WAN or LAN network, the Internet, or any other suitable medium.

The computer readable medium 208 may comprise code, executable by the processor 204. The computer readable medium 208 may contain any number of applications, modules, and code. The computer readable medium 208 can comprise code executable by the processor for implementing a method comprising: receiving, by a processing computer, a processing request message comprising user data from a remote server computer; determining, by the processing computer, latent values associated with the processing request message based on the user data and a multiplex graph; normalizing, by the processing computer, the latent values based on a community group in the multiplex graph, wherein the community group includes at least a part of the user data; and transmitting, by the processing computer, a processing response message comprising at least one normalized latent value to the remote server computer.

The latent value determination module 208A, in conjunction with the processor 204, can determine latent values from a multiplex graph comprising network data. The latent value determination module 208A, in conjunction with the processor 204, can determine latent values by creating adjacency matrices based on the multiplex graph and performing tensor factorization on the adjacency matrices.

The latent value determination module 208A, in conjunction with the processor 204, may first generate any suitable matrices based on the multiplex graph or, in some embodiments, based on a subset of network data of the multiplex graph. For example, the latent value determination module 208A, in conjunction with the processor 204, can generate an adjacency matrix, degree matrix, etc. As an example, an adjacency matrix and a degree matrix are shown in FIG. 9, and are described in further detail below. In some embodiments, the adjacency matrix can be generated based on network data representing a community group in the multiplex graph.

The latent value determination module 208A, in conjunction with the processor 204, can also perform tensor factorization on the adjacency matrix to determine latent values. In some embodiments, the latent value determination module 208A, in conjunction with the processor 204, can perform tensor factorization using the Tucker model. The Tucker model may decompose a tensor into a set of matrices and one small core tensor. In some embodiments, tensor factorization can also be referred to as tensor decomposition. Further details of the Tucker model can be found in section 4 of [Kolda, Tamara G., and Brett W. Bader. “Tensor decompositions and applications.” SIAM review 51.3 (2009): 455-500.], which is herein incorporated by reference in its entirety for all purposes. For further details on tensor factorization as well as its application to latent variables can be found in, for example, [Rabanser, Stephen, et al. “Introduction to Tensor Decompositions and their Applications in Machine Learning” in ArXiv (2017)], which is herein incorporated by reference in its entirety for all purposes. Further, examples of probabilistic latent tensor factorization for audio modeling can be found in, for example, [Cemgil, Ali Taylan, et al. “Probabilistic latent tensor factorization framework for audio modeling.” 2011 IEEE Workshop on Applications of Signal Processing to Audio and Acoustics (WASPAA). IEEE, 2011.], which is herein incorporated by reference in its entirety for all purposes. Still further details may be found in PCT Application No. ______, filed on the same day as the present application, and entitled “Event Monitoring and Response System and Method” (Attorney Docket No. 079900-1123964), which is herein incorporated by reference in its entirety and is assigned to the same assignee as the present application.

For instance, tensor factorization can be used to model three-way (or higher way) data by means of relatively small numbers of components for each of the three or more modes, and the components can be linked to each other by a three- (or higher-) way core array. The model parameters are estimated in such a way that, given fixed numbers of components, the modelled data optimally resembles the actual data in the least squares sense. The model can give a summary of the information in the data, in the same way as principal components analysis does for two-way data.

The processing computer 200 can factorize a tensor into a core tensor multiplied (or otherwise transformed) by a matrix along each mode. For example, as described in further detail in [Kolda, Tamara G., and Brett W. Bader. “Tensor decompositions and applications.” SIAM review 51.3 (2009): 455-500.], the three-way situation can be written as:

$$X \approx {\sum }_{p = 1}^{P} {\sum }_{q = 1}^{Q} {\sum }_{r = 1}^{R} {g}_{pqr} {a}_{p} ∘ {b}_{q} ∘ {c}_{r}$$

where g, a, b, and c correspond to a core tensor, a first factor matrix, a second factor matrix, and a third factor matrix, respectively. P, Q, and R, and respectively p, q, and r, represent the three dimensions of the tensor X. The symbol ∘ represents the vector outer product. These factor matrices can be considered the components in each mode of the core tensor corresponding to g. The core tensor can include entries which show the level of interaction between the different components. The combination of the factor matrices and the core tensor can be equal to the original tensor X.

The normalization module 208B, in conjunction with the processor 204, can create a normalized ranking of latent values (e.g., risk scores, risk score adjustors, etc.) based on a community group. The normalization module 208B, in conjunction with the processor 204, can perform normalization in any suitable manner as known to one of skill in the art. For example, the normalization module 208B, in conjunction with the processor 204, can determine the average latent value of the latent values for each user in the community group, and normalize each latent value based on the average latent value. In other embodiments, normalization can include normalizing the latent values with a probability distribution function (e.g., a Laplacian distribution, etc.).

As an illustrative example, the latent values can include 100 risk score adjustors. Each risk score adjustor may be associated with a particular node in the network data. The 100 risk score adjustors may include values ranging from 8 to 20. The normalization module 208B, in conjunction with the processor 204, can determine an average risk score adjustor equal to, for example, a value of 15. The normalization module 208B, in conjunction with the processor 204, can then divide each of the 100 risk score adjustors by the average risk score adjustor to determine 100 normalized risk score adjustors. For example, the risk score adjustors of 8 and 20 can be normalized to 0.53 and 1.33, respectively.

The communication module 208C, in conjunction with the processor 204, can be configured to transmit and receive data and information for communicating with other modules or entities. For examples, the communication module 208C, in conjunction with the processor 204, may transmit to and receive messages from the remote server computer. In some embodiments, the messages received from external entities may have been encoded and encrypted for secure communication. The communication module 208C, in conjunction with the processor 204, may decode and decrypt the message to determine whether the message is for a processing request message or any such message transmitted from the remote server computer. In some embodiments, the communication module 208C, in conjunction with the processor 204, may also be configured to format, encode and encrypt the messages transmitted to other entities, such as, the remote server computer.

The data store 220 can be similar to the data store 104 and will not be repeated here.

C. Remote Server Computer

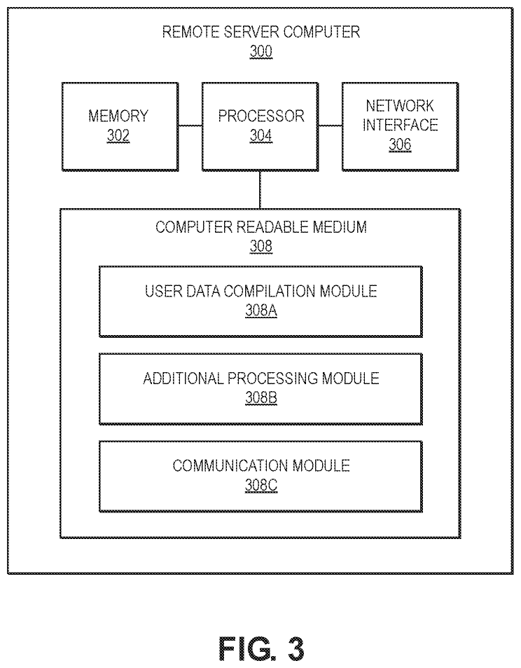

FIG. 3 shows a block diagram of a remote server computer 300 according to embodiments. The remote server computer 300 may comprise a comprise a memory 302, a processor 304, a network interface 306, and a computer readable medium 308 comprising a user data compilation module 308A, an additional processing module 308B, and a communication module 308C.

The memory 302 may store data securely. The memory 302 can store cryptographic keys, user data, routing tables, and/or any other suitable information used in conjunction with the modules. The network interface 306 can be similar to the network interface 206 and will not be repeated here.

The computer readable medium 308 may comprise code, executable by the processor 304. The computer readable medium 308 may contain any number of applications, modules, and code. The computer readable medium 308 can comprise code executable by the processor for implementing a method comprising: receiving, by a remote server computer, a user request; compiling, by the remote server computer, user data based on the user request; generating, by the remote server computer, a processing request message comprising the user data; transmitting, by the remote server computer, the processing request message to a processing computer, wherein the processing computer determines latent values associated with the user data and normalizes the latent values based on a community group, wherein the community group includes at least a part of the user data; receiving, by the remote server computer, a processing response message comprising at least one normalized latent value from the processing computer; and performing, by the remote server computer, additional processing based on the at least one normalized latent value.

The user data compilation module 308A, in conjunction with the processor 304, can compile user data relevant to a current user request (e.g., request for a loan a security clearance, access to a secure location, access to secure data, etc.). The user data compilation module 308A, in conjunction with the processor 304, can retrieve user data associated with the user from the memory 302. In some embodiments, the user data compilation module 308A, in conjunction with the processor 304, can receive user data from a user device.

The additional processing module 308B, in conjunction with the processor 304, can perform additional processing upon receiving a processing response message from the processing computer. The additional processing module 308B, in conjunction with the processor 304, can perform any suitable additional processing, for example, additional processing can include determining whether or not to grant the user's request (e.g., issue a loan, etc.), perform risk analysis if the received normalized latent value is less than a predetermined threshold, etc. In other embodiments, additional processing can include generating and transmitting an alert based on the output data to a remote computer, updating routing tables (e.g., based on the removal of a computer from a computer network), performing a fraud analysis, performing further analysis on the latent values and/or output data (e.g., adjusting a risk score with a risk score adjustor), and/or other processing based on the output of the model.

In some embodiments, the additional processing module 308B, in conjunction with the processor 304, can adjust a predetermined risk score with the normalized latent value received from the processing computer. For example, the remote server computer 300 may have previously determined a risk score for the user. The predetermined risk score may be, for example, 589. The normalized latent value may be a value of 1.2 as the user may have lower risk than their community. The additional processing module 308B, in conjunction with the processor 304, can adjust the risk score of 589 with the normalized latent value of 1.2. For example, the adjusted risk score may be equal to 589×1.2=707. The additional processing module 308B can then whether or not to grant the user request (e.g., issue the loan) based on the adjusted risk score.

The communication module 308C, in conjunction with the processor 304, can be similar to the communication module 208C and will not be repeated here.

### II. Methods

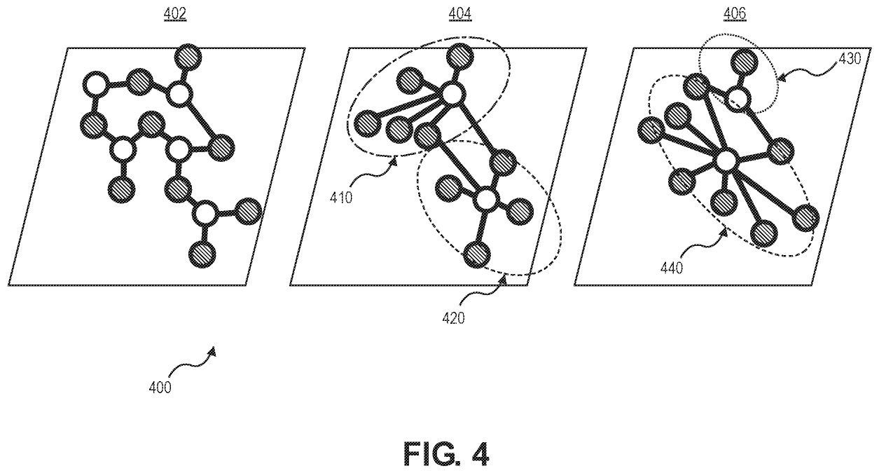

Embodiments can use the systems and apparatuses described above to process network data and user data to determine latent values. FIGS. 4-9 describe some examples of such methods. In some embodiments, the processing computer may include the processing computer 102 or 200 of FIGS. 1 and 2, respectively. The remote server computer may include the remote server computer 106 or 300 of FIGS. 1 and 3, respectively.

Some embodiments will be described in the context of determining whether or not a user is qualified for an interaction (e.g., a loan, a large transaction, etc.) and may be performed by a processing computer. For example, the processing computer can receive a processing request message comprising user data from a remote server computer. The processing computer can then determine latent values associated with the processing request message based on the user data and a multiplex graph. The processing computer can then normalize the latent values based on a community group in the multiplex graph. The community group can include at least a part of the user data. The processing computer can then transmit a processing response message comprising at least one normalized latent value to the remote server computer.

Generally, graph technologies and tensor factorization may be used to extract latent values from a community group that can then be used to normalize a risk value of a particular user. Several use cases are described below, however, it is understood that embodiments of the invention may involve other use cases. The use cases below give some examples of the information that latent variables can provide.

A. Multiplex Graphs

The network data stored in the data store 104 can be used to form a multiplex graph. Network data can include any suitable network data. For example, network data can include purchase network data, fraud network data, returns network data, weather network data, water usage network data, temperature reading network data, etc. A multiplex network can comprise a plurality of network data. For example, a multiplex network can comprise purchase network data, fraud network data, and returns network data.

FIG. 4 shows a multiplex graph 400 according to embodiments. The multiplex graph 400 can also be referred to as a multidimensional network. The multiplex graph 400 can comprise first network data 402, second network data 404, and third network data 406. However, it is understood that the multiplex graph 400 can comprise any suitable amount of network data. In some embodiments, the multiplex graph 400 can be expressed as a tensor. The true relationship between users and resource providers can be a hyper graph, but can be expressed as a bipartite graph for ease. However, a simple bipartite graph removes too much information, such as, information regarding if two users connected via a first resource provider or second resource provider. To solve this the relationship can be expressed as the multiplex graph 400.

For example, the nodes of the first network data 402 may include nodes that represent resource providers and users connected via edges that represent purchase (i.e., transactions). For example, a user may transact with a resource provider to purchase a television. Data associated with the transaction can include any suitable data, for example, a date and time, an amount, and/or other transaction details. The user node can include data indicating the user (e.g., a name, a PAN, etc.). The resource provider node can include data indicating the resource provider (e.g., resource provider ID, name, etc.).

The nodes of the second network data 404 may include nodes associated with fraud. The nodes may be connected via edges. An edge that connects two fraud nodes may represent an instances of fraud. The plain nodes in the second network data 404 can indicate resource providers and the striped nodes in the second network data 404 can indicate users (i.e., cardholders). The edges connecting a resource provider node to a user node can indicate an instance of fraud. For example, a user node and a resource provider node can be connected by an edge in the second network data 404 if fraud was reported for a transaction that occurred between the user and the resource provider. Data associated with the fraudulent transaction (or other fraud) can include any suitable data, for example, a date and time, an amount, and/or other transaction details. The user node can include data indicating the user (e.g., a name, a PAN, etc.). The resource provider node can include data indicating the resource provider (e.g., resource provider ID, name, etc.). Additionally, the second network data 404 is an example of a bipartite graph, as resource provider nodes are not connected to resource provider nodes, and user nodes are not connected to user nodes.

As an illustrative example of community groups, the second network data 404 and the third network data 406 include a plurality of community groups (410, 420, 430, and 440). For example, the second network data 404 can include a credit card fraud community 410 and a check fraud community 420, however, it is understood that the community groups 410 and 420 can be any community groups determined from the second network data 404.

The nodes of the third network data 406 may include nodes of resource providers and users that are connected via edges indicating returns. The edges (i.e., returns of a product purchased in a previous transaction) may connect a resource provider to a user. The nodes in the first network data 402, the second network data 404, and the third network data 406 may be connected via edges to one another. For example, a node in the first network data 402 related to a node in the second network data 404 can be related to a node a return in the third network data 406. For example, the purchase of the television may be a fraudulent purchase and the purchased product may have been returned to the resource provider. Additionally, the third network data 406 includes two community groups (430 and 440). As an example, the community groups can be a large return community 430 and a small return community 440.

In some embodiments, the multiplex graph 400 can change over time as new data is added to the multiplex graph 400. The multiplex graph 400 may portray auto-regressive characteristics. For example, in some embodiments, processing computer can normalize the data in the multiplex graph. For example, the latent values can be normalized using an autoregressive integrated moving average (ARIMA) model. The processing computer can compute the ARMIA model as known to one of skill in the art.

Autoregressive data may include variables that depend on their own previous values. For example, a user may perform repeat transactions with a resource provider due to a number of factors including ads, availability, convenience, preferences, and/or propensities. The ARIMA model can take autoregressive data into account. It can take into account three major aspects including autoregression (AR), integrated (I), and moving average (MA). The AR aspect can be a model that uses the dependent relationship between an observation and some number of lagged observations. The integrated aspect can be the use of differencing of raw observations (e.g. subtracting an observation from an observation at the previous time step) in order to make the time series stationary. The MA aspect can include a model that uses the dependency between an observation and a residual error from a moving average model applied to lagged observations.

Each of these components can be specified in the model as a parameter. A standard notation is used of ARIMA(p, d, q) where the parameters are substituted with integer values to quickly indicate the specific ARIMA model being used. The parameters of the ARIMA model can include:

| | |
|---|---|
| p | The number of lag observations included in the model, also |
| | called the lag order |
| d | The number of times that the raw observations are differenced, |
| | also called the degree of differencing |
| q | The size of the moving average window, also called the order |
| | of moving average |

Autoregressive data can include data that depends on its previous values. For example, a user may perform repeat transactions with a resource provider if the user is loyal to the resource provider. As another example, a fraudster may perform similar types of fraud due to their skill set. For example, a fraudster may perform repeated attempts of online credit card fraud. An ARIMA method can allow the processor computer to take autoregressive data into account when analyzing the plurality of network data. For further details on ARIMA see [Box, George E P, et al. Time series analysis: forecasting and control. John Wiley & Sons, 2015.], which is herein incorporated in its entirety for all purposes.

B. Request Processing

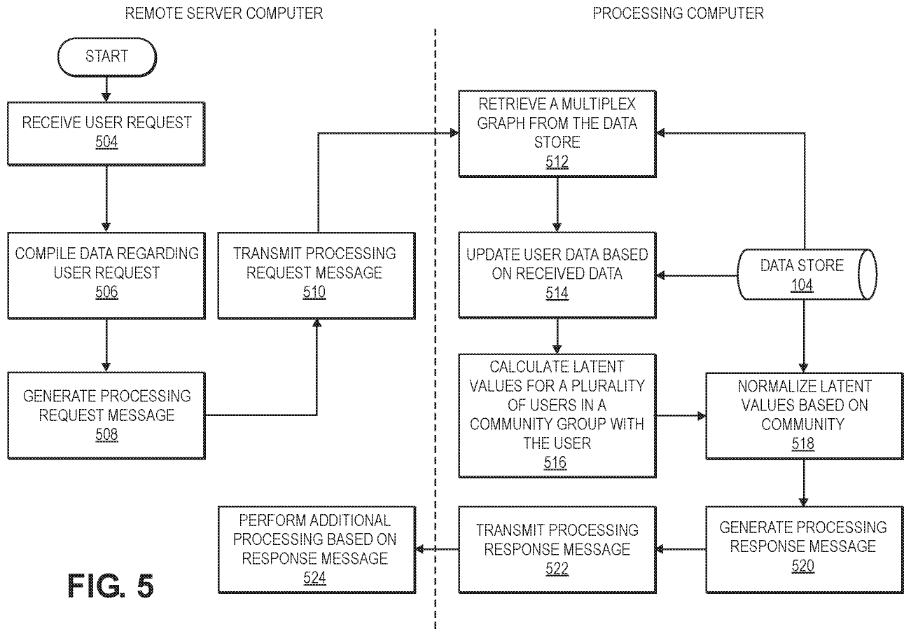

FIG. 5 shows a method of processing a request according to an embodiment of the invention. The method illustrated in FIG. 5 will be described in the context of a user requesting a security/performance analysis of a computer. An additional example of a user requesting a home loan at a bank will also be described. The latent variables in this example may be risk score adjustors. However, embodiments of the invention are not limited thereto, it is understood that the invention can be applied to other circumstances (e.g., a user requesting a security clearance, a user requesting access to secure data, etc.). Although the steps are illustrated in a specific order, it is understood that embodiments of the invention may include methods that have the steps in different orders. In addition, steps may be omitted or added and may still be within embodiments of the invention.

At step 504, the user may request a security/performance analysis of a computer at the remote server computer 106. The remote server computer 106 can receive a user request comprising the request. In some embodiments, the remote server computer 106 can receive the user request from a user device (e.g., mobile phone, laptop computer, etc.). In other embodiments, the remote server computer 106 can receive the user request from a terminal computer located at the user's location. The user request can include any suitable data related to the request that the user is making. For example, the user request may include an IP address of the computer, a previously determined risk score, etc.

As another example, the user may request a home loan at a bank. The bank may operate the remote server computer 106. In some embodiments, the user may request any other service offered by the bank. In other embodiments, the request may be from a group of people and/or a company. For example, a group of people may request a building permit from a local government. The user request may include, for example, an amount of the loan, a length of time of the loan, etc.

At step 506, the remote server computer 106 can gather any suitable user data related to the user based on the user request. The remote server computer 106 can compile data including, for example, risk scores, credit scores, phone numbers, physical addresses, email addresses, data habits, account numbers, etc. In some embodiments, the remote server computer 106 can receive user data along with the user request. In other embodiments, the remote server computer 106 can retrieve user data from a user data database, which can include any conventional, fault tolerant, relational, scalable, secure database.

For example, after receiving the user request from the user device, the remote server computer 106 can determine what user data is needed for the received user request. If the user request is a request for a security/performance analysis, then the remote server computer 106 can use a look up table to determine what user data to compile for the user request. If the user request is a request for a $50,000 loan for 5 years, then the remote server computer 106 can determine that the user data to compile includes name, income, current debts, and residence location. For example, the look up table may be as follows:

| User Request | User Data |
|---|---|
| Loan | Name, income, current debts, and residence |
| | location. |
| Security/performance | Name, computer IP address, risk score, |
| analysis | suitable access codes, and type of computer |
| | hardware. |
| Building permit | Name, building location, building plans, and |
| | contractor information. |

After determining the user data to compile, the remote server computer 106 can query one or more suitable user data databases for the relevant user data. In some embodiments, if the user data database does not have a particular data item for the user data (e.g., income, etc.) stored, then the remote server computer 106 can request the user to input the missing user data. For example, the user's income may not be stored in the user data database. The remote server computer 106 can then request the user to input the user's income.

At step 508, the remote server computer 106 can generate a processing request message. The processing request message may include a request for normalized latent values relating to the user's request, for example, the request for a security/performance analysis or the request for a loan. In some embodiments, the latent values can be associated with the latent variable of risk score adjustors. In some embodiments, the processing request message may also include the user data. In yet other embodiments, the processing request message can further comprise the sender's IP address, the intended receiver's IP address, a packet number if the message is split into a plurality of data packets, cryptographic keys (e.g., public keys), and/or any other suitable information aiding the security and/or integrity of the processing request message.

At step 510, the remote server computer 106 can transmit the processing request message to the processing computer 102. In some embodiments, the remote server computer 106 can transmit the processing request message using any suitable application programming interface (API).

At step 512, after receiving the processing request message from the remote server computer 106, the processing computer 102 may retrieve a multiplex graph comprising a plurality of network data from the data store 104. The network data in the multiplex graph can include additional user data. The additional user data can include any user data stored in the data store 104 that was not received from the remote server computer 106. For example, the additional user data can include spending habits, employment history, weekday and weekend habits, etc.

The multiplex graph can comprise a plurality of network data including, for example, physical performance network data, application network data, and communication traffic network data. For example, the physical performance network data may include RAM utilization, CPU processing rates, and free memory space. The application network data may include number of queries/operations processed, number of parallel instances emulated, and application error rates. The communication traffic network data may include communication durations, communication failure rates, communication channel types, and communication rates of particular machines.

As another example, the multiplex graph can comprise a plurality of network data including, for example, employment network data, transaction network data, and debt network data. For example, the employment network data may include salaries and employment histories. The transaction network data may include transaction types, resource providers, purchase amounts, etc. The debt network data may include outstanding debts, amounts previously paid off, interest rates, and bankruptcy information.

In some embodiments, at step 514, after retrieving the multiplex graph, the processing computer 102 may update the multiplex graph with the received user data, if the received user data is not already included in the multiplex graph. For example, if the data in the data store 104 contains outdated user data, compared to the received user data, then the processing computer 102 may store the received user data in the data store 104. In some embodiments, the processing computer 102 may determine whether or not the received user data is more recent than the data stored in the data store 104 (e.g., via a timestamp of the data). In some embodiments, the processing computer 102 may determine the most recent data.

For example, the processing computer 102 can compare the user data to previously stored user data in a data store to determine most recent user data, where latent values will be determined, as described herein, based on the most recent user data and the multiplex graph. The processing computer 102 can then store the most recent user data in the data store.

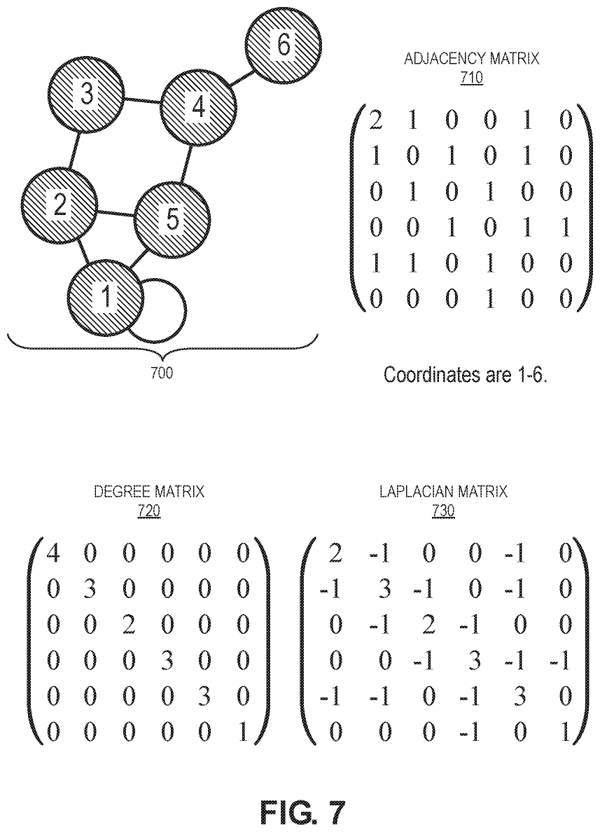

At step 516, after retrieving the multiplex graph, the processing computer 102 can determine a latent value for each user represented in the multiplex graph. For example, the latent variables may be risk score adjustors. A risk score adjustor can be an integer, float, double, etc. (e.g., 1.8, 33, etc.). In some embodiments, a risk score adjustor can be a latent value. The processor computer 102, or in some embodiments the remote server computer 106, can use a risk score adjustor to adjust a risk score in any suitable manner. The processor computer 102, or in some embodiments the remote server computer 106, can multiply, or perform any other mathematical operation with, a risk score adjustor and a risk score. For example, the processor computer 102 can multiply a risk score adjustor of 1.8 and a risk score of 650 to determine an adjusted risk score of 1170. To determine the latent values, the processing computer 102 can generate an adjacency matrix based on the plurality of network data in the multiplex graph to encode the plurality of network data into a matrix for tensor factorization. The processing computer 102 may generate the adjacency matrix based on the graph, for example, if the processing computer 102 determines that the graph indicates that a node is connected to another node via an edge, then the processing computer 102 can store the connection information into an adjacency matrix. For example, the adjacency matrix can include elements which can indicate whether pairs of vertices are adjacent or not in the graph. An example, adjacency matrix is shown in FIG. 7 and described in further detail below. In some embodiments, the processing computer 102 can generate the adjacency matrix from a portion of the multiplex graph or from the full multiplex graph.

In some embodiments, the adjacency matrix can be generated based on a community group determined from the multiplex graph. The processing computer 102 can determine the community groups using any suitable method known to one of skill in the art. For example, the processing computer 102 can generate the community groups using clustering techniques on the multiplex graph. In some embodiments, the processing computer 102 can determine the community groups prior to receiving the processing request message. Data regarding the community groups can be stored in the data store 104 or other data base, and can be retrieved at step 512 along with the multiplex graph. In other embodiments, the processing computer 102 can determine the community groups on-the-fly when receiving the processing request message. For further details regarding community groups, see [Fortunato, Santo. “Community detection in graphs.” Physics reports 486.3-5 (2010): 75-174.], which is herein incorporated by reference for all purposes.

The community, that the adjacency matrix is based on, may be, for example, users associated with the operator of the remote server computer 106. In some embodiments, the community group may include nodes representing computers in a computer network as well as the computer that the user requested a security/performance analysis for. As another example, the community, that the adjacency matrix is based on, may be, for example, individuals associated with the bank (e.g., account holders, cardholders, etc.). In some embodiments, the community may be associated with other characteristics such as geographic location (e.g., city, zip code, county, state, etc.), computer hardware type, computer software type, computer throughput level (e.g., data rates), spending habits (e.g., high spenders, low spenders, etc.), and/or any other characteristics that can define a community group. In other embodiments, the users of the community may have credit cards issued from the bank.

For example, the processing computer 102 can determine a high throughput level community group which can include nodes representing computers that have high levels of input data and output data compared to other computers. As another example, the processing computer 102 can determine a location based community group based on zip code, county, district, city, state, etc. After determining the adjacency matrix from a community group, the processing computer 102 can proceed to perform tensor factorization on the adjacency matrix.

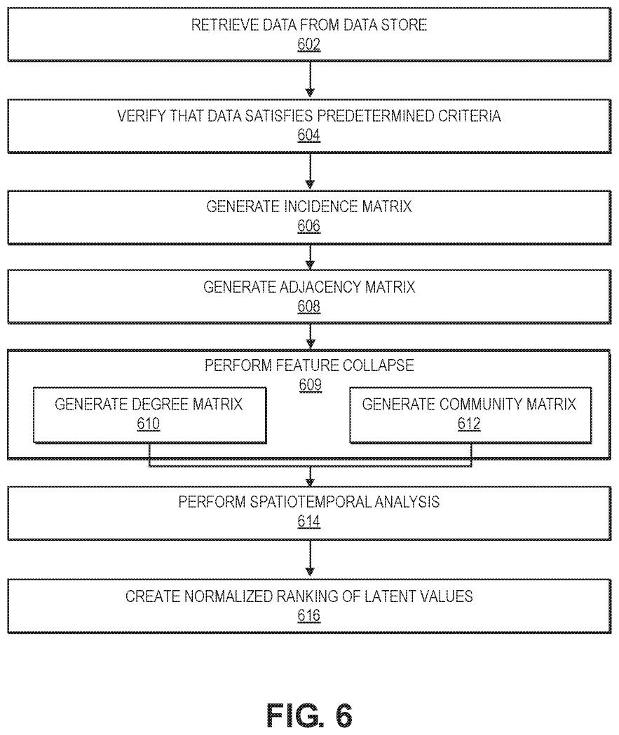

After generating the adjacency matrix, the processing computer 102 may perform tensor factorization on the adjacency matrix to obtain latent values, as described herein. In some embodiments, tensor factorization may be performed using the Tucker model. The Tucker model may decompose a tensor into a set of matrices and one small core tensor. Tensor factorization is described in further detail in FIG. 6. The latent values can be a result of tensor factorization. In some embodiments, the latent values may be included in a tensor, for example, in a rank 2 tensor.

As an example, the adjacency matrix can be input into the latent value determination module 208A included in the processing computer 102. The adjacency matrix can be a rank 2 tensor. The processing computer 102 can factorize the adjacency matrix into a plurality of smaller tensors, which combined together can be equivalent to the adjacency matrix. At least one of the smaller tensors can include one or more latent values. For example, in some embodiments, at least one of the smaller tensors can include a rank 2 tensor that is of size m×m, where m<n. In other embodiments, the at least one of the smaller tensors may not be a square matrix, but may still include fewer elements than the adjacency matrix.

If the adjacency matrix was created based on high throughput level community group (e.g., the nodes in the community group are associated with computers that have high usage), then at least one of the smaller tensors, resulting from tensor factorization, can include latent values relating to a latent variable of “risk score adjustor.” The latent values can be, for example, 1.8, 1.5, 0.8, 0.6, and 1.2, where each latent value may correspond to a different computer. These latent values may indicate a computer failure risk score adjustor. For example, the computer failure risk score adjustor usage can indirectly depend on the physical computer performance network data (e.g., high CPU processing rates), on the application performance network data (e.g., due to the computer only being able to process one application at a time), and on the communication traffic network data (e.g., due to the number of corrupted transmissions).

As another example, if the adjacency matrix was created based on a community group associated with the user's city, then at least one of the smaller tensors, resulting from tensor factorization, can include latent values relating to a latent variable of “risk score adjustor.” The latent values can be, for example, 1.2, 1.0, 0.7, 1.5, and 1.1, where each latent value can correspond to a different individual living in the city. These latent values may indicate a risk score adjustor to adjust a risk score for a loan. For example, the risk score adjustor can indirectly depend on the employment network data (e.g., steady employment history), transaction network data (e.g., low rates of purchase large ticket items), and debt network data (e.g., low amounts of outstanding debt and many paid off loans).

At step 518, after determining the latent values for each user in the community group, the processing computer 102 may normalize the latent values based on the community group. Any suitable method of normalization may be used. The processing computer 102 can normalize the latent values using a determined average latent value. The average latent value can be the average of the latent values determined for each user in the community, a weighted average, etc. As another example, the processing computer 102 can normalize the latent values using a probability distribution, as known to one of skill in the art.

For example, the latent values can include 100 risk score adjustors (e.g., computer failure risk score adjustor). Each risk score adjustor may be associated with a particular node in the plurality of network data. The 100 risk score adjustors may include values ranging from 8 to 20. The processing computer 102 can determine an average risk score adjustor equal to, for example, a value of 15. The processing computer 102 can then divide each of the 100 risk score adjustors by the average risk score adjustor to determine 100 normalized risk score adjustors. For example, the risk score adjustors of 8 and 20 can be normalized to 0.53 and 1.33, respectively.

In some embodiments, after normalizing the latent values, the processing computer 102 can adjust a risk score received in the user data from the remote server computer 106, with the normalized latent value associated with the user. For example, the remote server computer 106 may have received a risk score of 308 in the processing request message. After determining the latent value (e.g., a risk score adjustor equal to 1.1), the processing computer 102 can adjust the received risk score with the determined risk score adjustor (e.g., 308*1.1=338.8). As another example, the processing computer 102 can determine the risk score adjustor to be 97 and adjust the received risk score to be 308+97=405. The processing computer 102 can then generate and transmit a processing response message comprising the adjusted risk score to the remote server computer 106.

At step 520, after normalizing the latent values, the processing computer 102 can generate a processing response message comprising the normalized latent value associated with the user. The processing computer 102 can keep track of which latent value is associated with the user by the latent value's position (i.e., element) in the tensor including the latent values. For example, the tensor including the latent values may be a rank 2 tensor (i.e., a matrix). A particular element (e.g., element (101,43), element(12,872), etc.) can correspond to the user request (e.g., a computer for which the user requested a security/performance analysis, or the user's request for a loan).

In some embodiments, the processing response message can comprise all of the normalized latent values determined from the users in the community. In other embodiments, the processing response message can also include the user data previously received from the remote server computer 106.

At step 522, the processing computer 102 may transmit the processing response message to the remote server computer 106 over any suitable communication channel.

At step 524, after receiving the processing response message, the remote server computer 106 may perform additional processing based on the normalized latent value. For example, additional processing can include determining whether or not the computer needs to be replaced. As another example, additional processing can include determining whether or not to authorize the request received from the user. For example, the remote server computer 106 may determine to authorize the loan for the user or that the computer needs to be replaced based on the normalized latent variables (e.g., a normalized risk score adjustor). In some embodiments, the remote server computer 106 may have previously determined (or received from a third-party) a risk score (e.g., 52). The remote server computer 106 can adjust the risk score with the normalized latent value (of the user). For example, the normalized latent value can be 0.9. The remote server computer 106 can determine an adjusted risk score of, for example, 52×0.9=46.8. The remote server computer 106 can then determine whether or not to authorize the user's request based on the adjusted risk score. In some embodiments, if the remote server computer 106 determines that the computer needs to be replaced, then the remote server computer 106 can generate new routing tables based on the removal of the computer from a plurality of computers.

In other embodiments, the remote server computer 106 can determine that the adjusted risk score indicates that the computer has a high probability of being compromised by a malicious party. The remote server computer 106 can then perform suitable security methods, such as quarantining the potentially malicious computer by ceasing all communication with the potentially malicious computer.

In some embodiments, additional processing can include determining whether or not to authorize the request received from the user. For example, the remote server computer 106 may determine to authorize the loan for the user using the normalized latent values (e.g., a normalized risk score adjustor). For example, the remote server computer 106 can adjust a risk score (that was previously determined) using the normalized risk score adjustor. If the adjusted risk score is suitable (e.g., over a predetermined threshold, or surpasses other requirements), then the remote server computer 106 can determine to authorize the loan.

C. Latent Value Detection

Further details of latent value detection via tensor factorization are described below. FIG. 6 shows a method of latent value detection in a dynamic hyper network with autoregressive features according to an embodiment of the invention. The method illustrated in FIG. 6 will be described in the context of a determining latent variables of risk score adjustors. It is understood, however, that the invention can be applied to other circumstances (e.g., latent variables of categories, data structures, economic trends, weather, transaction data, human characteristics, mental states, etc.). Although the steps are illustrated in a specific order, it is understood that embodiments of the invention may include methods that have the steps in different orders. In addition, steps may be omitted or added and may still be within embodiments of the invention. In some embodiments, the method of latent value detection in a multiplex graph with autoregressive features described in FIG. 6 may be performed at steps 512-518 in FIG. 5.

At step 602, the processing computer 102 may query a data store 104 for a multiplex graph. The multiplex graph can comprise a plurality of network data, as described herein. At step 604, after retrieving the multiplex graph, the processing computer 102 can filter the data of the multiplex graph. Filtering the multiplex graph based on at least one predetermined criterion. For example, the processing computer 102 can filter the data based on a requirement that all users and resource providers can be stored in the preceding and following data. In other words, the processing computer 102 can filter out temporally non-continuous data. The processing computer 102 can also filter the data based on, for example, measurement error of the data.

As another example, the processing computer 102 can filter data such that the plurality of network data includes temporally continuous data. In other words, the processing computer 102 can filter the plurality of network data to include nodes that are included in consecutive timestamps. In some embodiments, the processing computer 102 can filter the user data based on at least one predetermined criterion. In other embodiments, the processing computer 102 can perform an ARIMA method to adjust the data for autoregressive characteristics as described above.

At step 606, after filtering the data, the processing computer 102 may generate an incidence matrix based on the multiplex graph. An incidence matrix may be a matrix that shows the relationship between two classes of objects. For example, if a first class is “resource provider” and a second class is “user,” then the matrix may include one row for each element of resource provider and one column for each element of user. In some embodiments, any suitable method of constructing an incidence matrix may be used and the incidence matrix may be in any suitable format as known to one of skill in the art.

An incidence matrix can be related to an adjacency matrix, and in some embodiments, can aid in the generation of the adjacency matrix. For example, an unoriented incidence matrix of a graph G can be related to the adjacency matric of its line graph L(G) by the following theorem:

A(L(G))=B(G)^{T}B(G)−2Iₘ

where A(L(G)) is the adjacency matrix of the line graph of G, B(G) is the incidence matrix, and Iₘ is the identity matrix of dimension m.

At step 608, after generating the incidence matrix, the processing computer 102 may generate an adjacency matrix. An adjacency matrix may be a matrix that indicates whether pairs of nodes are adjacent or not in the multiplex graphs. In some embodiments, the adjacency matrix may be a square matrix. For example, a graph may include the graph 700 shown in FIG. 7. For example, the graph 700 includes nodes 1, 2, 3, 4, 5, and 6 as well as 8 edges. The processing computer 102 can generate the adjacency matrix 710 based on the graph 700. The adjacency matrix 710 can have the coordinates of 1-6. For example, the first row and column correspond to node 1, the second row and column correspond to node 2, the third row and column correspond to node 3, etc. The first element (0,0) in the adjacency matrix 710 is a 2 since the first node is connected to the first node 2 times. The element at position (6,4) corresponds to the number of edges that connect nodes 6 and 4, which is equal to 1.

In some embodiments, at step 609, the processing computer 102 determine to perform feature collapse as described below, during which, the processing computer can generate a degree matrix at step 610 and generate a community matrix at step 612.

At step 610, the processing computer 102 may generate a degree matrix. A degree matrix may be a matrix that contains information about the degree of each node. In some embodiments, the degree matrix may be a diagonal matrix. In some embodiments, the degree matrix and the adjacency matrix may be used to determine a Laplacian matrix of a graph. In some embodiments, a degree matrix D and an adjacency matrix A may be used to determine a Laplacian matrix L of a graph. For example, L=D−A. For example, the processing computer 102 can generate the degree matrix 720 shown in FIG. 7 based on the graph 700. Each element in the degree matrix 720 indicates the number of edges connected to a given node. For example, node 5 is connected to 3 edges in graph 700. Thus, in the degree matrix 720, at position (5,5), the element is equal to 3.

In some embodiments, after generating the adjacency matrix, the processing computer 102 may generate a normalized Laplacian matrix. A Laplacian matrix can be a matrix representation of a graph. The processing computer 102 can generate the Laplacian matrix 730 based on the adjacency matrix 710 and the degree matrix 720. For example, the processing computer 102 can subtract the adjacency matrix 710 from the degree matrix 720, element-wise, to obtain the Laplacian matrix 730. In some embodiments, the processing computer 102 can also normalize the Laplacian matrix 730 as known to one of skill in the art.

In some embodiments, at step 612, the processing computer 102 may generate a community matrix. A community matrix may be a matrix that includes information regarding a community. The community matrix can be create in any suitable manner as known to one of skill in the art.

For example, in some embodiments, after calculating the adjacency matrix at step 608, the processing computer 102 may determine if it is desirable to perform feature collapse at step 609. Feature collapse can include collapsing the network data into smaller graphs of condensed information. For example, the processing computer 102 can collapse the network data from 1,000 nodes to 100 nodes, where each of the new 100 nodes represents multiple similar nodes of the network data. In some embodiments, the processing computer 102 can perform K-core decomposition to perform feature collapse, as known to one of skill in the art. The processing computer 102 may perform the feature collapse in steps 610 and 612. At step 610 and 612, the processing computer 102 may determine a degree matrix and a community matrix (e.g., determined using K-core decomposition). The degree matrix and community matrix can include data from determined communities.

Feature collapse may decrease the number of total nodes in the network data, thus improving downstream computation times, while retaining accuracy of the data. The processing computer 102 can perform K-core decomposition on the network data to reduce the number of nodes. For example, the network data may be purchase network data including nodes representing resource providers as well as nodes representing users (i.e., consumers). The edges connecting the user nodes to the resource provider nodes can indicate an interaction between the two, such as a transaction. In some embodiments, to find a k-core graph, the processing computer 102 can to remove the nodes that have degree less than k, which may be predetermined (e.g., 2, 3, 5, etc.). The processing computer 102 can determine a new degree matrix based on the removed nodes, since removing nodes will also remove edges connected to the removed nodes.

In some embodiments, the processing computer 102 can decrease the number of total nodes by combining similar nodes. For example, if multiple nodes have similar characteristics (e.g., resource provider nodes indicating various store locations of a franchise), the processing computer 102 can combine these nodes into one node (i.e., a core node).

In some embodiments, the processing computer 102 can perform tensor factorization on at least the adjacency matrix to determine latent values. In some embodiments, tensor factorization may be performed using the Tucker model, which can decompose a tensor into a set of matrices and one small core tensor.

Leveraging the network data in the multiplex graph, the processing computer can derive latent values via tensor factorization. For instance, tensor factorization can be used to model three-way (or higher way) data by means of relatively small numbers of components for each of the three or more modes, and the components are linked to each other by a three- (or higher-) way core array. The model parameters are estimated in such a way that, given fixed numbers of components, the modelled data optimally resemble the actual data in the least squares sense. The model can give a summary of the information in the data, in the same way as principal components analysis does for two-way data.

At step 614, after generating the incidence matrix, the adjacency matrix, the degree matrix, and the community matrix, the processing computer 102 may perform four-dimensional spatiotemporal analysis. In some embodiments, four-dimensional spatiotemporal analysis may be latent Dirichlet allocation. Latent Dirichlet allocation may be a generative statistical model that allows sets of data to be explained by unobserved data or latent data that can explain various trends or patterns. Further details regarding latent Dirichlet allocation can be found in [Blei, David M., Andrew Y. Ng, and Michael I. Jordan. “Latent dirichlet allocation.” Journal of machine Learning research 3. January (2003): 993-1022.], which is herein incorporated by references in its entirety for all purposes. In some embodiments, the four-dimensional spatiotemporal analysis can use a distance measure to calculate how far the latent value of the user is from a center node that has been calculated for the community. Additionally, it can allow for a user to be in multiple communities. In some embodiments, the latent values can be normalized using latent dirichlet allocation.

Spatiotemporal analysis can use a distance measure to determine how far a node is from a center node of its community group. For example, if a latent variable of “risk score adjustor” has a latent value of 1.4, then the spatiotemporal analysis can determine how far away the node (including the latent value) is from the center node of its community group. The distance of each node in the community group can be used to normalize the latent values determined for each node. For example, the processing computer 102 can determine a vector in the community's variable space for each node, and then normalize the latent variables based on the determined vectors.

In some embodiments, at step 616, the processing computer 102 may create a normalized ranking for prioritization based on peer groups (i.e., communities) and the latent values. For example, in the case that the user requested a loan from a bank, the processing computer 102 may determine a normalized latent value (e.g., risk score adjustor) for the user. The normalized risk score adjustor may be normalized based on the risk score adjustors of others in a community with the user. The risk score determined by a third party can be adjusted with the normalized risk score adjustor to determine an adjusted risk score. An example of the risk scores and the latent normalized risk scores are shown in the table below. The table includes three users to illustrate a comparison between different users.

| | Risk Score | Normalized Latent value | Adjusted risk score |
|---|---|---|---|
| First User | 12 | 1.8 | 21.6 |
| Second User | 78 | 0.3 | 23.4 |
| Third User | 34 | 1.2 | 40.8 |

In this example, the second user originally was associated with a risk score of 78, where the risk score may be determined by the bank. However, the processing computer 102 determined that the latent normalized risk score 0.3, which indicates that the latent normalized risk score is lower than the average user in the same community as the second user. For example, the second user may live in an underprivileged area of town, but may have a higher rate of paying off a car loan than others in the town, as well as other positive attributes. In this way, the specific attributes of the user can be used to determine their eligibility for requests.

In comparison, the first user was associated with a risk score of 12 (e.g., by the bank). The processing computer 102 determined that the latent normalized risk score 1.8 indicates that the first user has a higher risk score than the average user in the same community as the first user. For example, the first user may have high income but is in more debt than the average user in the community. Other data can also influence the determination of the first user's latent normalized risk score (e.g., shopping habits, criminal history, social credit score, etc.).

Embodiments of the invention provide for a number of advantages. For example, a user's request can be authorized based on their own attributes and characteristics rather than a broad generalization of their community's attributes and characteristics. Embodiments of the invention allow for the determination of latent values which can be used to normalize a user's data risk score to provide their relative risk and return based on their peers, thus eliminating issues with relying only on past performance of a community and increase inclusion.

Embodiments of the invention have a number of advantages. For example, determining an adjusted risk score using latent values determined via tensor factorization can be more transparent as to how the risk score is adjusted than by using deep learners to determine risk scores.

It should be understood that any of the embodiments of the present invention can be implemented in the form of control logic using hardware (e.g. an application specific integrated circuit or field programmable gate array) and/or using computer software with a generally programmable processor in a modular or integrated manner. As used herein, a processor includes a single-core processor, multi-core processor on a same integrated chip, or multiple processing units on a single circuit board or networked. Based on the disclosure and teachings provided herein, a person of ordinary skill in the art will know and appreciate other ways and/or methods to implement embodiments of the present invention using hardware and a combination of hardware and software.

Any of the software components or functions described in this application may be implemented as software code to be executed by a processor using any suitable computer language such as, for example, Java, C, C++, C#, Objective-C, Swift, or scripting language such as Perl or Python using, for example, conventional or object-oriented techniques. The software code may be stored as a series of instructions or commands on a computer readable medium for storage and/or transmission, suitable media include random access memory (RAM), a read only memory (ROM), a magnetic medium such as a hard-drive or a floppy disk, or an optical medium such as a compact disk (CD) or DVD (digital versatile disk), flash memory, and the like. The computer readable medium may be any combination of such storage or transmission devices.

Such programs may also be encoded and transmitted using carrier signals adapted for transmission via wired, optical, and/or wireless networks conforming to a variety of protocols, including the Internet. As such, a computer readable medium according to an embodiment of the present invention may be created using a data signal encoded with such programs. Computer readable media encoded with the program code may be packaged with a compatible device or provided separately from other devices (e.g., via Internet download). Any such computer readable medium may reside on or within a single computer product (e.g. a hard drive, a CD, or an entire computer system), and may be present on or within different computer products within a system or network. A computer system may include a monitor, printer, or other suitable display for providing any of the results mentioned herein to a user.

The above description is illustrative and is not restrictive. Many variations of the invention will become apparent to those skilled in the art upon review of the disclosure. The scope of the invention should, therefore, be determined not with reference to the above description, but instead should be determined with reference to the pending claims along with their full scope or equivalents.

One or more features from any embodiment may be combined with one or more features of any other embodiment without departing from the scope of the invention.

As used herein, the use of “a,” “an,” or “the” is intended to mean “at least one,” unless specifically indicated to the contrary.

1. A method comprising:
receiving, by a processing computer, a processing request message comprising user data from a remote server computer;
determining, by the processing computer, latent values associated with the processing request message based on the user data and a multiplex graph;
normalizing, by the processing computer, the latent values based on a community group in the multiplex graph, wherein the community group includes at least a part of the user data; and
transmitting, by the processing computer, a processing response message comprising at least one normalized latent value to the remote server computer.

2. The method of claim 1, wherein determining latent values further comprises:
generating, by the processing computer, an incidence matrix, an adjacency matrix, a degree matrix, and a community matrix based on the user data, the multiplex graph, and the community group; and
performing, by the processing computer, tensor factorization on the incidence matrix, the adjacency matrix, the degree matrix, and the community matrix to determine latent values.

3. The method of claim 1 further comprising:
filtering, by the processing computer, the multiplex graph based on at least one predetermined criterion.

4. The method of claim 1 further comprising:
comparing, by the processing computer, the user data to previously stored user data in a data store to determine most recent user data; wherein determining latent values associated with the processing request message is based on the most recent user data and the multiplex graph; and
storing, by the processing computer, the most recent user data in the data store.

5. The method of claim 4, further comprising:
retrieving, by the processing computer, the previously stored user data and the multiplex graph from the data store.

6. The method of claim 4, wherein the multiplex graph includes data regarding users associated with the remote server computer.

7. The method of claim 4, wherein the latent values correspond to latent variables of risk score adjustors and wherein the at least one normalized latent value corresponds to a latent variable of a normalized risk score adjustor corresponding to a user of the user data.

8. The method of claim 7, wherein the latent values are normalized using latent dirichlet allocation.

9. The method of claim 1, wherein the remote server computer receives the at least one normalized latent value and adjusts a risk score corresponding to a user's request using the normalized latent value.

10. A processing computer comprising:
a processor; and
a computer-readable medium coupled to the processor, the computer-readable medium comprising code executable by the processor for implementing a method comprising:
receiving a processing request message comprising user data from a remote server computer;
determining latent values associated with the processing request message based on the user data and a multiplex graph;
normalizing the latent values based on a community group in the multiplex graph, wherein the community group includes at least a part of the user data; and
transmitting a processing response message comprising at least one normalized latent value to the remote server computer.

11. The processing computer of claim 10, wherein determining latent values further comprises:
generating an incidence matrix, an adjacency matrix, a degree matrix, and a community matrix based on the user data, the multiplex graph, and the community group; and
performing tensor factorization on the incidence matrix, the adjacency matrix, the degree matrix, and the community matrix to determine latent values.

12. The processing computer of claim 10, wherein the method further comprises:
filtering the multiplex graph based on at least one predetermined criterion.

13. The processing computer of claim 10, wherein the method further comprises:
comparing the user data to previously stored user data in a data store to determine most recent user data; wherein determining latent values associated with the processing request message is based on the most recent user data and the multiplex graph; and
storing the most recent user data in the data store.

14. The processing computer of claim 13, wherein the method further comprises:
retrieving the previously stored user data and the multiplex graph from the data store.

15. The processing computer of claim 10, wherein the multiplex graph includes data regarding users associated with the remote server computer.

16. The processing computer of claim 10, wherein the latent values correspond to latent variables risk score adjustors and wherein the at least one normalized latent value corresponds to a latent variable of a normalized risk score adjustor corresponding to a user of the user data.

17. The processing computer of claim 16, wherein the latent values are normalized using latent dirichlet allocation.

18. The processing computer of claim 10, wherein the remote server computer receives the at least one normalized latent value and adjusts a risk score corresponding to a user's request using the normalized latent value.

19. A method comprising:
receiving, by a remote server computer, a user request;
compiling, by the remote server computer, user data based on the user request;
generating, by the remote server computer, a processing request message comprising the user data;
transmitting, by the remote server computer, the processing request message to a processing computer, wherein the processing computer determines latent values associated with the user data and normalizes the latent values based on a community group, wherein the community group includes at least a part of the user data;
receiving, by the remote server computer, a processing response message comprising at least one normalized latent value from the processing computer; and
performing, by the remote server computer, additional processing based on the at least one normalized latent value.

20. The method of claim 19, wherein performing additional processing further comprises:
adjusting, by the remote server computer, a risk score associated with the user request with the at least one normalized latent value.

21.-26. (canceled)
